(19) United States
(12) Patent Application Publication
(10) Pub. No.: US 2024/0220673 A1
(43) Pub. Date: Jul. 4, 2024

(54) SYSTEM, DEVICE AND METHOD FOR INSTALLATION PROJECT VISUALIZATION AND APPROVAL

(71) Applicant: CapTech Ventures, Inc., Richmond, VA (US)

(72) Inventors: Robert Andrew Bratton, Charlotte, NC (US); Amanda Harvey, Midlothian, VA (US); Cathryn Bruce, Richmond, VA (US); Shannon Flowerday, Ann Arbor, MI (US); Benjamin Nowak, Glen Allen, VA (US); Ryan Donovan, Mount Pleasant, SC (US); Andrew Gray, West Chester, PA (US); Christian Saca, Weaverville, NC (US); Bryce McCall, Denver, CO (US); Kelsey Haviland, Miami, FL (US); Maria Ziech-Lopez, Atlanta, GA (US)

(21) Appl. No.: 18/091,886

(22) Filed: Dec. 30, 2022

(51) Int. Cl. G06F 30/13; G06T 7/60; G06T 11/60; H04N 5/77; H04N 7/18

(52) U.S. Cl. CPC G06F 30/13; G06T 7/60; G06T 11/60; H04N 5/77; H04N 7/183; G06F 2111/18; G06T 2200/24

(57) ABSTRACT

Embodiments of a system, device and method provide for visualizing and approving installation projects via receiving one or more images of an installation environment and supplementing the image(s) with one or more virtual objects, one or more measurements and/or one or more notations. In various embodiments, images are customized by a first user for review and approval by a second user.

### TECHNICAL FIELD

The present disclosure pertains to electronic communications, and more particularly to a system, device and method for visualizing and approving installation projects.

### BACKGROUND AND SUMMARY

Renewable energy equipment, telecommunications equipment, power infrastructure equipment and other equipment and ancillary items for physical installation can take many forms, including solar panels, battery charging equipment and stations, cable/broadband and other telecommunications equipment, satellite equipment, energy generation equipment and ancillary landscaping and artistic structures, for example. Historically, project designers may propose equipment and other physical item installations to landowners and other decision makers using blueprints, photographs and measurements in an effort to obtain selection and approval of desired items prior to such items being installed.

In many instances, these past approaches can negatively affect landowners and other decision makers, who may under-appreciate the effects of certain sizes and types of equipment until the equipment is actually installed. Additional difficulties with past approaches include insufficient and inefficient collection and recording of approvals for equipment installations from landowners and other decision makers. Still further difficulties with past approaches include, for example, the inability to capture accurate measurements and distances associated with planned equipment locations vis-a-vis other objects at an installation site, which can negatively affect the quality of execution of construction activities, thereby potentially compromising customer satisfaction and potentially compromising safety for construction crews.

Embodiments of the present disclosure address the above deficiencies and more. In various embodiments, the present disclosure provides a custom solution employing augmented reality, custom feature elements and three-dimensional (3D) imaging to, among other things: gain customer approval for the adoption of new utility equipment that supports electric grid resiliency and renewable energy products and resources through a custom visualization display; capture customer approval on object placement through a custom feature workflow and screen capture that can include additional meta data, such as, address and coordinates of the virtual object, custom notes, and approval in or as part of the saved image; provide a novel method for design engineers, field workers, and customer outreach specialists to capture desired measurements (including vertically and horizontally) of custom virtual object placements with other virtual and/or stationary objects to support quality execution of construction activities to achieve higher customer satisfaction and promote the safety of construction crews; provide integration features with geographical information systems (GIS) to enable visualization of existing equipment within the application, that is not visible, to enable the protection of existing assets and safety of construction crews; partially remove objects from a unique image capture to support the visualization for vegetation management processes and work order creation for tree trimming providers; and provide the ability for customers to access custom objects, including 3D objects that are maintained within a cloud virtual library.

Embodiments of the present disclosure incorporate a combination of elements included in the image capture to support desired outcomes of customer adoption and increased quality of construction execution, such as virtual object placement, captured object spacing measurements, customer approvals, virtual object placement coordinates, address, and custom notes available within or as part of the image capture. In various implementations, custom “exception” measurements can be captured for objects, enabling the user to see directly within the image if another object is placed too close to another object. A machine learning model can be incorporated in various embodiments to increase the accuracy of coordinate information captured in a unique screen capture for customer approvals. In different embodiments, objects can be partially removed within the custom image capture to support work management activities, such as vegetation management, for example.

Through all of the above, and as described herein, the presently disclosed system, device and method provide a technical solution to the challenges encountered by many user types associated with presenting equipment and related objects for review, customization and approval to support effective and efficient physical installation projects.

### BRIEF DESCRIPTION OF THE DRAWINGS

FIG. 1 is a schematic diagram illustrating an exemplary device in accordance with embodiments of the present disclosure.

FIG. 2 is a schematic diagram illustrating an exemplary system according to embodiments of the present disclosure.

FIGS. 3 through 17 are exemplary displays illustrating aspects of embodiments of the present disclosure.

FIGS. 18 and 19 are exemplary flow diagrams illustrating aspects of embodiments of the present disclosure.

### DETAILED DESCRIPTION OF EMBODIMENTS

The presently disclosed subject matter now will be described more fully hereinafter with reference to the accompanying drawings, in which some, but not all embodiments of the presently disclosed subject matter are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated drawings. Therefore, it is to be understood that the presently disclosed subject matter is not to be limited to the specific embodiments disclosed and that modifications and other embodiments are intended to be included within the scope of the appended claims.

It will be appreciated that reference to “a”, “an” or other indefinite article in the present disclosure encompasses one or more than one of the described element. Thus, for example, reference to a device may encompass one or more devices, reference to an image may encompass one or more images, and so forth.

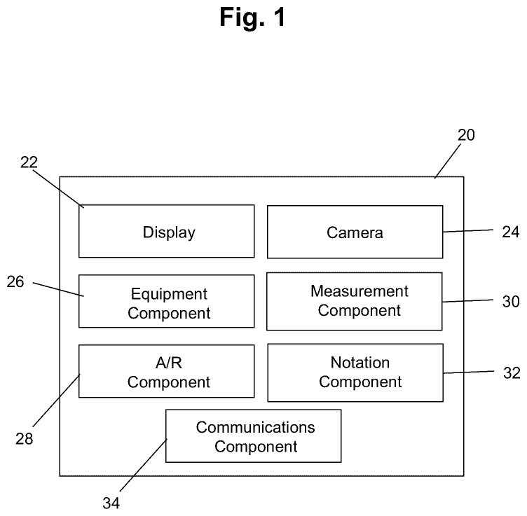

As shown in FIG. 1, embodiments of a device 20 in accordance with the present disclosure can include components that provide hardware and/or programming for the functions as described herein. A display 22 provides hardware and programming for displaying images, whether as still images or moving images, as supplemented by augmented reality and/or other supplements as described herein. In various embodiments, the device 20 also includes a camera 24 for capturing images to be displayed. The device 20 can further include an equipment component 26, which can store images, dimensions and other relevant information and programming related to various types of equipment and ancillary physical items that may be desirable for rendering on the display in accordance with the present disclosure. An augmented reality (“A/R”) component 28 provides programming for rendering two-dimensional (2D), 3D, animated and other visualizations of items such as different types of equipment from equipment component 26. The visualizations can be rendered as an overlay on images displayed by the display 22. A measurement component 30 is provided for enabling the measurement of items and dimensions presented on the display. It will be appreciated that the measurement component 30 can facilitate measurement in the horizontal, vertical or other direction, and such measurements can be taken between (1) objects displayed in an original image or images captured by the camera, (2) objects displayed as A/R elements overlain on the display of the original image(s), and/or (3) one or more objects displayed in an original image and one or more objects displayed as A/R element.

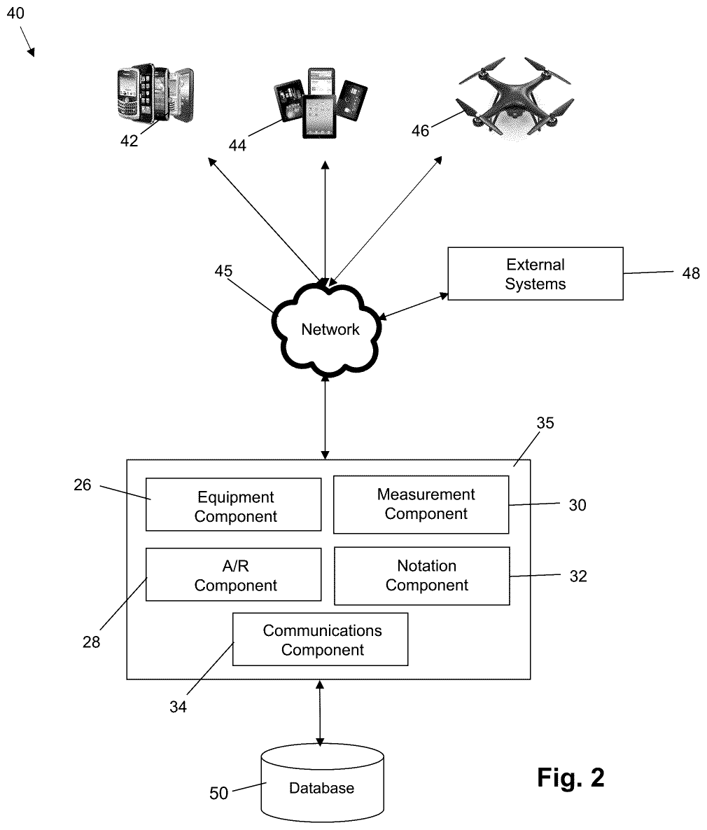

As further shown in FIG. 1, the device 20 can include a notation component 32 for permitting input from a given source to be rendered in textual or other format alongside any A/R elements and as an overlay on one or more original images on the display. A communications component 34 can also be provided for communicating images as supplemented herein to devices and/or other systems remote from device 20. Such communications can occur over a network as described in connection with FIG. 2. In various embodiments, device 20 can be a tablet or smartphone computing device. It will be appreciated that equipment component 26, A/R component 28, measurement component 30 and/or notation component 32 can be provided individually or in aggregation as a software application that may be downloaded to the device 20 for use locally thereon.

FIG. 2 is a schematic diagram of an embodiment of a system 40 in accordance with the present disclosure. As shown therein, various types of devices and systems 42, 44, 46, 48 are shown in communication with a remote device 35 via network 45. The devices can include, for example, smartphone devices 42, notebook, laptop, tablet and related devices 44, and camera-enabled drone devices 46, for example. External systems 48 can include remote government or GIS databases that may provide access to information that may be helpful in populating certain fields to be employed and/or displayed in accordance with the present disclosure. External systems 48 can further include remote computing systems such as a corporate network system that may employ device 35 as a remote and/or cloud-based solution for a plurality of potential equipment installation projects, for example. In embodiments according to FIG. 2, remote device 35 may not include a camera and display, but rather one or more of devices 42, 44, 46 may be used to capture real-world images of equipment installation environments via an internal camera and one or more of devices 42, 44 may be used to display such images as supplemented according to the present disclosure. It will be appreciated that devices 42, 44 can operate as device 20 in FIG. 1, wherein versions of equipment component 26, A/R component 28, measurement component 30 and/or notation component 32 can be provided individually or in aggregation as a software application that may be downloaded to the devices 42, 44 for use locally thereon. In certain embodiments, a user such as a project designer can employ a device 44 such as a tablet computing device to capture images of an installation environment, supplement the images as described herein, record the images and issue a notification and/or communicate the supplemented images to remote device 35 or to another device 42 such as a smartphone of a landowner, for example, whereupon the landowner can review the project designer's saved image(s) and approve or reject a proposed project installation.

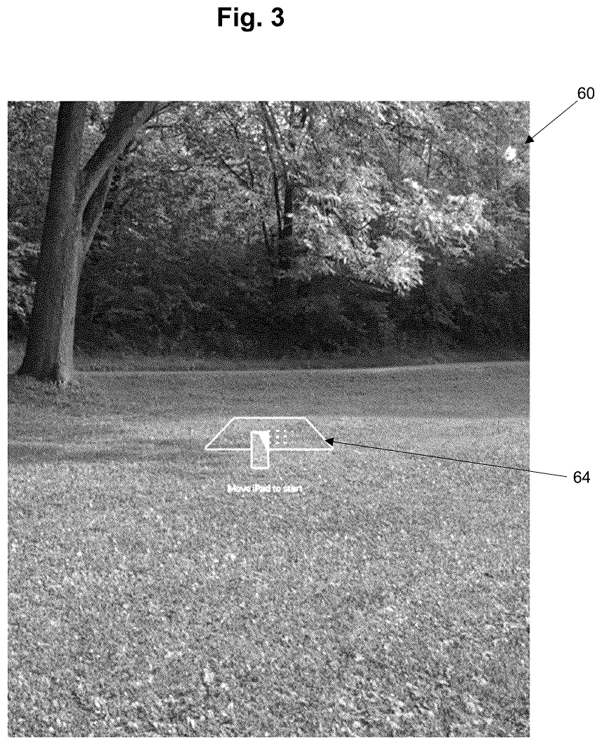

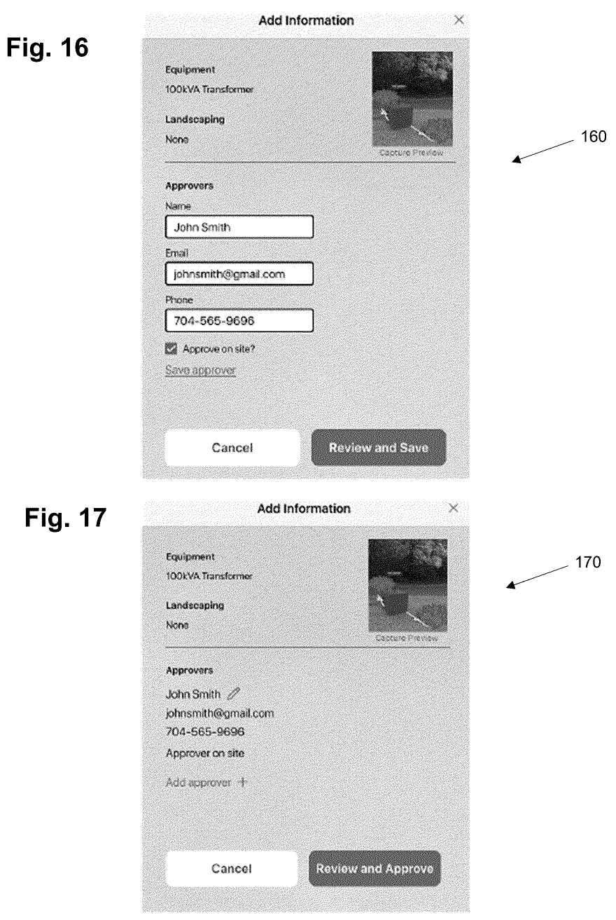

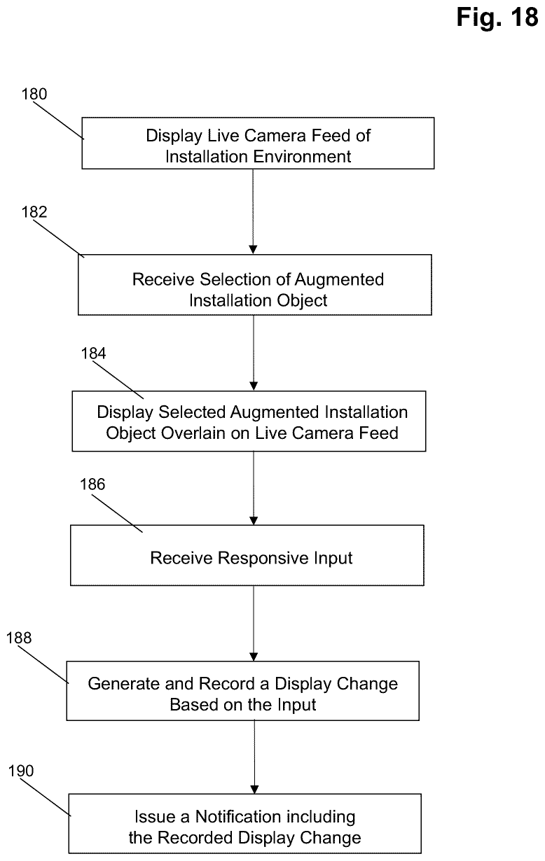

FIGS. 3 through 17 illustrate display images with various types of supplements in accordance with the present disclosure. It will be appreciated that a supplement can be a prompt for a user to enter information or select points to measure from/to, and can further be a virtual, A/R overlay, a notation, a button, a measurement, a reticle movement, a removal of an object or element from a captured image, a landscaping enhancement or other addition or subtraction constituting a change to the originally captured image(s) from the camera of the computing device.

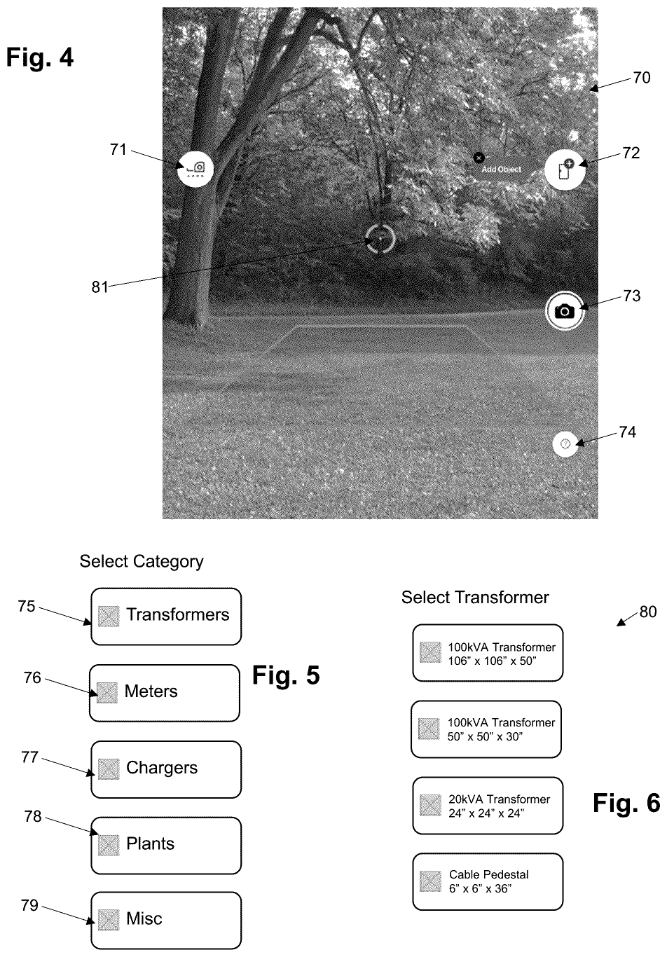

For example, FIG. 3 shows a display 60 with an image of an installation environment. The display 60 can be a live image of an installation environment and can be shown on a hardware display such as display 22 or a display of another computing device (e.g., 42, 44) as will be understood to those of ordinary skill. The display 60 can include a supplement 64 such as in the form of an animation or prompt for a user of a device with a camera to move the device (e.g., an iPad™) to start the process of finding the ground plane and recording images of the installation environment for use as described herein. FIG. 4 shows display 70 with supplements in the form of icons or buttons that permit a user to implement various functions according to the present disclosure. For example, if a user selects object drawer button 72 such as through a touchscreen interface, the display 70 may be modified such that the user can view various options for one or more augmented installation objects that may be overlain upon the image in the display 70. For example, FIG. 5 shows optional augmented installation objects including transformers 75, meters, 76, chargers 77, plants 78 and miscellaneous 79 that may be selected by a user. Further sub-options can be shown as in FIG. 6, where a user having selected transformers at 75 in FIG. 5 can select from a menu 80 of transformers to be shown on the image in the display. In various embodiments, dimensional information is displayed in the menu 80 alongside respective descriptions of the various augmented installation objects to assist the user in making selections. If a user selects measurement button 71, the measurement functions described elsewhere herein can be employed. In various embodiments, invoking measurement button 71 can disable the ordinarily available function of adding and moving objects within the installation environment shown on the display. If a user selects camera button 73, the recording of images via the device camera may begin and it will be appreciated that the recording of images can including recording raw images of an installation environment or images as supplemented with A/R features, measurements and/or notations as described herein. If a user selects a “Help” button such as shown at 74, various tool tips and other help related features can be displayed and/or employed.

When the user desires to select equipment to be displayed, the user may first provide input such as through a touchscreen, mouse or keyboard, for example, regarding where the equipment should initially be positioned in the display. For example, a reticle (e.g., 81 in FIG. 3) can be dragged and dropped via touchscreen to a location in the image where the equipment to be selected will be positioned, at least initially. In various embodiments, a preview of a selected augmented installation object may be shown in semi-transparent form and can be locked on the screen where the reticle 81 is placed. In various embodiments, the preview can be moved around the installation environment depicted on the display as the user moves the computing device. If the resulting display is unsatisfactory, the user can return to the initial screen with the ground plane identified by selecting a “cancel” button on the display.

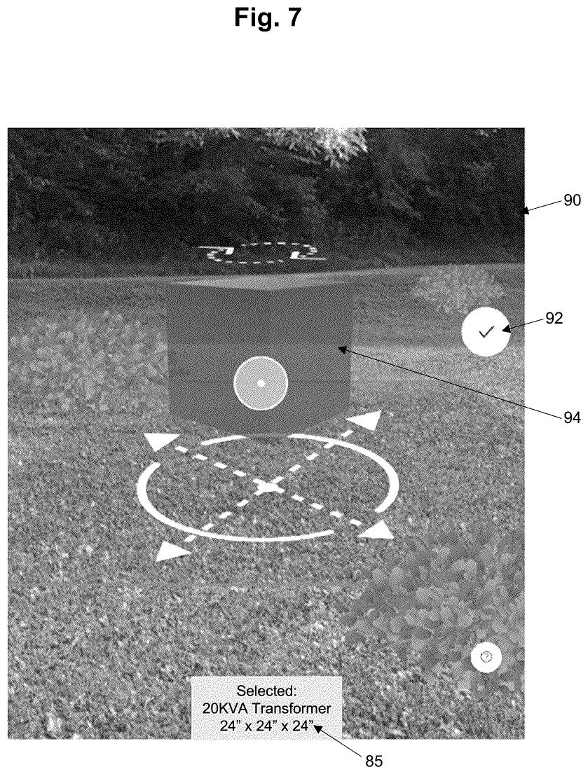

As shown in display 90 of FIG. 7, a checkmark button is shown at 92. Once the checkmark button is selected, the augmented installation object (e.g., 94) is placed in the location of the installation environment where the object is being previewed. In various embodiments, once the object is placed, it can be rotated, moved and otherwise manipulated as desired by the user according to user input. It will be appreciated that user inputs can be received via touchscreen, microphone, keyboard, mouse or other such input. As described elsewhere herein, once the object is placed, the user can select various buttons such as the measurement button 71 or camera button 73 in FIG. 4. Upon selecting the camera button 73, a screenshot of the image as supplemented by the object and any descriptive information (e.g., 85 in FIG. 7) can be captured. It will be appreciated that users may employ embodiments of the present disclosure to add more than one augmented installation object in the display. For example, a user may select an augmented reality transformer and an augmented reality landscaping feature to be displayed on the same display.

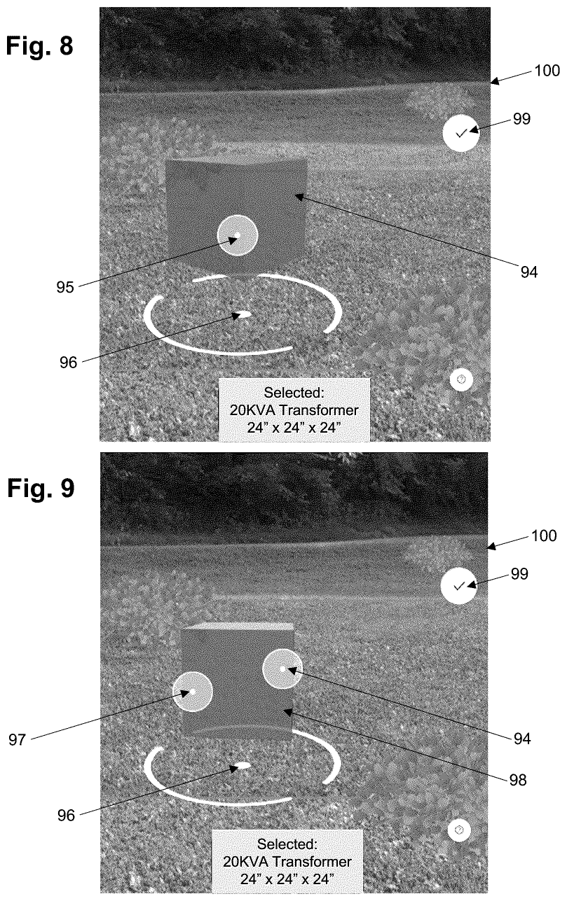

The repositioning of an augmented installation object can occur as described herein with reference to display 100 of FIGS. 8 and 9. As shown in FIG. 8, augmented installation object 94 can be selected for movement. At such time, the display 100 may optionally be changed such that the object 94 is changed to transparent or some specific color, such that any ground shadow associated with the object is removed, such that the object is lifted a small distance above where it had been placed, and/or such that the object visually bounces within the display 100, for example. In various embodiments, the user can touch the screen at a single point (e.g., 95 in FIG. 8) to move the object 94 without affecting the orientation of the object 94. In various embodiments, the user can touch the screen at two points (e.g., 97 and 98 in FIG. 8) to re-orient the object 94 without moving the object 94. A ground location on the display such as at 96 can represent where the object 94 will be positioned once the user disengages from the touchscreen and selects the checkmark 99, for example. At such time as the object 94 is placed in the installation environment, any changes in color, opacity, shadow and/or vertical position of the object can be returned to the original setting. In various embodiments, unnecessary user interface elements such as measurement touchscreen button and camera touchscreen button are removed or hidden while an object is selected. In various other embodiments, guides for movement controls are displayed around the selected object in the display to assist user operation.

It will be appreciated that, according to various embodiments, the A/R component 28 can change captured images representing real-world installation environments to remove features such as physical objects shown in the images for design, proposal and approval purposes. For example, if a captured image shows a large bush, and it would be desirable to remove the large bush in order to facilitate the desired equipment installation, the A/R component 28 can operate to edit the captured image to remove the large bush and replace it with suitable environmentally appropriate features such as grass or mulch, for example, so that the adapted image projects a near-real image that can be further supplemented as described herein.

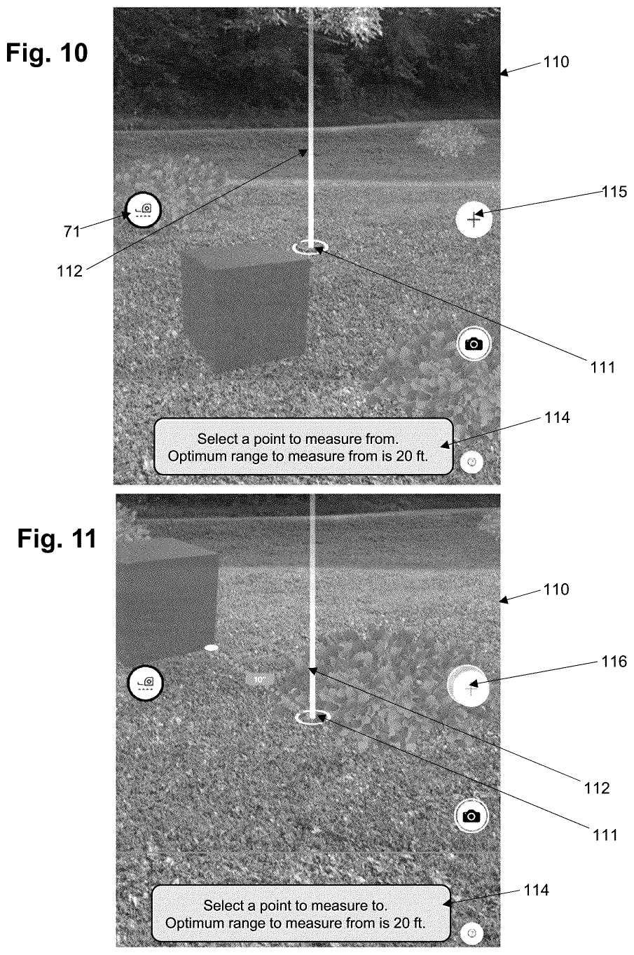

Employing measurement capabilities in accordance with the present disclosure can occur with reference to FIGS. 10 through 12, for example. As shown in display 110 of FIGS. 10 and 11, upon selecting the measurement button 71, the user can be prompted to select an origin point from which measurements are to be taken. Such prompt can be in the form of a ground plane reticle 111 that the user moves to a desired location. In various embodiments, the ground plane reticle will have a pillar (e.g., 112) attached to it for ease of recognition. The prompt can further be or include text-based instructions (e.g., 114) on the display. An “add measurement starting point” button 115 can be presented as shown in FIG. 10, and once a starting point is selected such as by moving the ground plane reticle 111 and/or moving the computing device such that the reticle is moved around different locations in the field of view of the camera, the user can select an “add measurement ending point” button 116 as shown in FIG. 11, after which the user can touch the screen or provide other input such as by moving the computing device to inform where the measurement should end. In various embodiments, the measurement component 30 considers what equipment has been selected and other elements in the display, including one or more real-life elements from the installation environment and one or more augmented or virtual elements overlain on the display, in determining an optimal distance for placement of desired equipment for the purpose of improving later construction activities and/or customer satisfaction, for example. In various embodiments, a live readout of the distance between the starting and ending points is generated and displayed on the display.

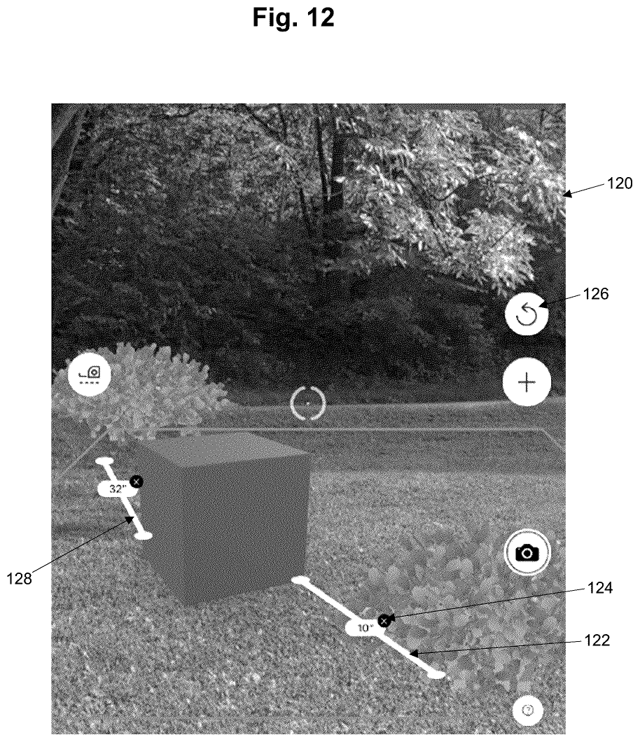

As shown in the display 120 of FIG. 12, once the starting and ending points are selected and confirmed, the measurement component 30 can instruct the display (e.g., 22) to turn the dimension line to a solid line (e.g., 122) of one color (e.g., white) with the actual measurement also being displayed. In various embodiments, if desired, the line can be deleted in a number of ways, including by selecting a close button (e.g., 124) displayed next to the dimension line, or by selecting a “clear dimensions” button (e.g., 126) on the display. Additional dimensions can be added on each display, as shown in FIG. 12, such that the display 120 includes multiple measurements (e.g., 122, 128).

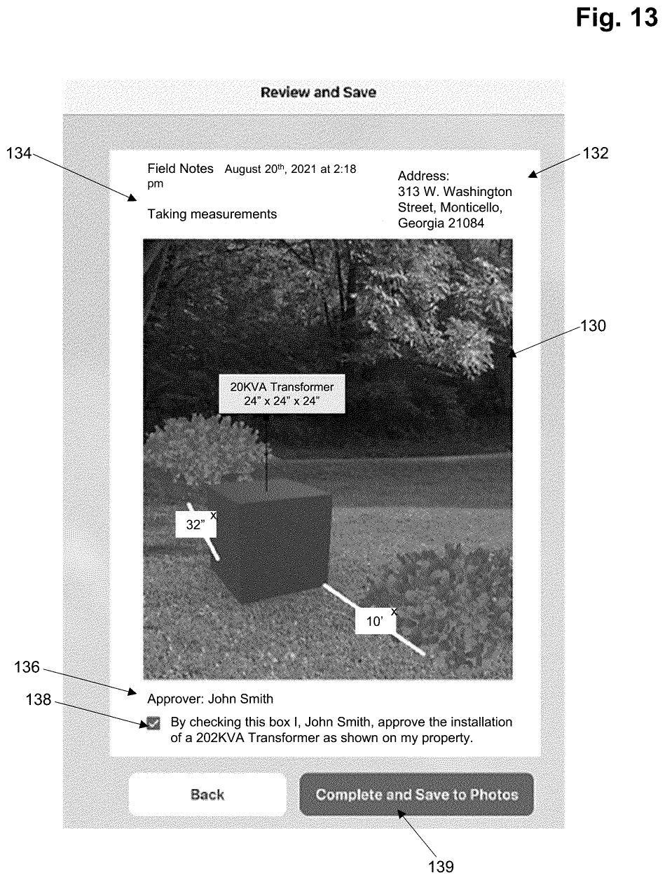

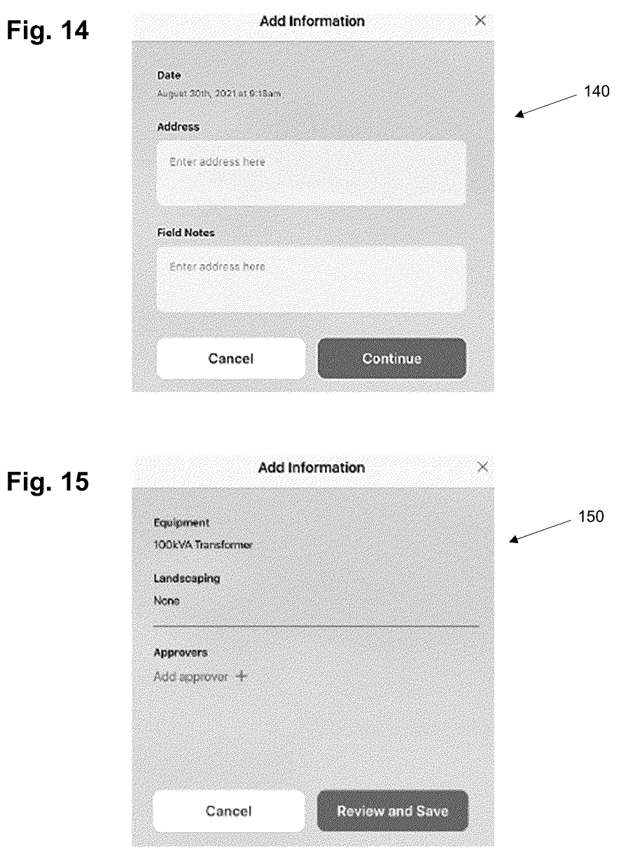

Adding desirable notations and presenting the display for customer approval can occur as shown, for example, in FIGS. 13 through 17. As shown in FIG. 13, once an image 130 with desired objects and measurements has been captured, an address notation 132, field notes 134, an approver name 136, an approver consent 138 and/or a form of augmentation object label (e.g., transformer name/size) can be presented on or adjacent the display of the image 130. Such added items can be considered verbal notations and can be presented as words and/or numbers desired to facilitate the notational and approval purposes of the present disclosure. The address notation 132 can be determined by data entry or by GIS functionality determined according to the determined location of the device capturing the image(s) of the installation environment. The field notes 134 can be entered by onsite personnel (e.g., an individual operating the computing device capturing the image(s) of the installation environment). For example, the field notes 134 may specify instructions for a reviewer or a construction crew, such as the direction of water runoff, notes regarding surrounding properties and other information. The approver name 136 can be entered by a device operator or by the approver himself or herself. FIGS. 14 through 17 show exemplary user interfaces 140, 150, 160, 170 for such purposes as described. In various embodiments, the computing device capturing the image(s) and permitting object placement, movement and measurements communicates the captured and labeled image(s) to a remote device for review and approval, such as via network 45 in FIG. 2. Once approved, the approval with referenced images can be saved for future use by project installation personnel, for example.

FIG. 18 illustrates an exemplary process flow in accordance with embodiments of the present disclosure. As shown at 180, a live camera feed of an installation environment is shown on a display, such as in FIG. 3, for example. As at 182, a selection of an augmented installation object is received, such as by a user selecting an object from the object drawer, such as represented by FIGS. 4 through 6, for example. As at 184, the selected augmented installation object is virtually displayed as an overlay on the displayed live camera feed, such as in FIG. 7, for example. As at 186, input is received in response to the image with the virtually displayed overlay, and as at 188, a display change is generated and recorded based on the input. The input can take various forms, including moving an object, deleting an object, rotating an object, measuring a distance, requesting the capture of an image and other input as described herein. It will be appreciated that the input makes the image identifiable and actionable, in the sense that relevant geographical coordinates can be captured and custom notes such as where landowners desire an object to be installed or other such notes can be employed. As at 190, a notification is issued including the recorded display change. The notification can be, for example, a communication to another user such as a landowner, a regulating authority or other user for approval, comments, additional instructions to the end user, suggested changes and other such further input.

In certain embodiments, it will be appreciated that a party such as a landowner reviewing a project designer's supplemented images may further adapt such images through the user of A/R component 28, equipment component 26, measurement component 30 and/or notation component 32, such as via remote device 35 in FIG. 2 or via locally stored versions of such components on the user's device (e.g., 42 or 44 in FIG. 2). For example, a project designer may store a recommended equipment installation for a transformer of size S on landowner A's property, wherein the recommended installation is represented by images of the installation environment on landowner A's property and wherein the images are overlain with an A/R representation of a transformer of size S in a certain position in the northeast area of the installation environment. The stored images may further show a dimension line indicating the distance from a tree to the transformer in the installation environment. The project designer can communicate the supplemented image(s) to landowner A via a notification that can include a text message, e-mail communication or other form of communication that may travel over a network such as network 45 in FIG. 2. If, for example, landowner A desires to adjust the position of the transformer, landowner A may use the A/R component 28, whether as part of remote device 35 or as stored locally on landowner A's device, to manipulate the position of the transformer. Similarly, landowner A may use equipment component 26 to change the size of the transformer from size S to size T. Landowner A may further use measurement component 30 to evaluate measurements on the image(s) such as, for example, ensuring that the transformer is a certain minimum distance from the tree in the installation environment. Landowner A may also use notation component 32 to approve of the project designer's recommendation or make requests for the project designer to make adjustments to the recommendation.

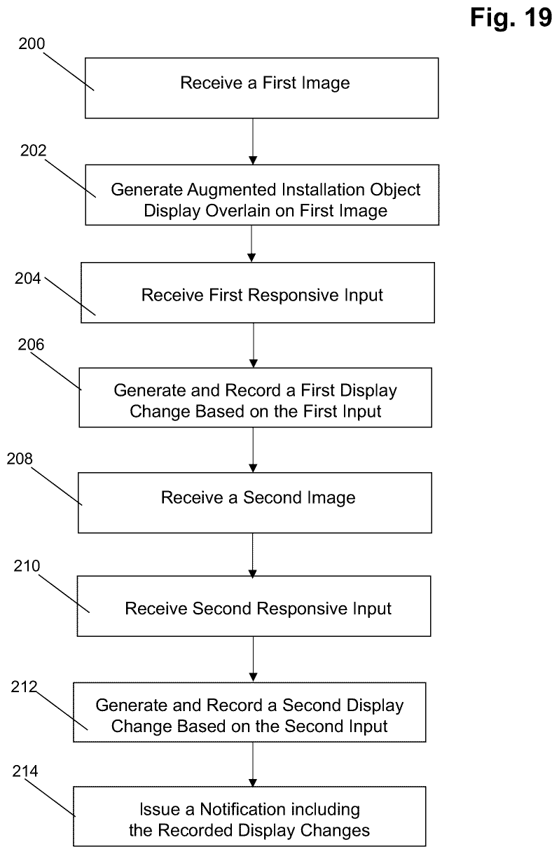

FIG. 19 illustrates another exemplary process flow in accordance with embodiments of the present disclosure. As shown at 200, a first image of an installation environment is received, such as from a camera, and such image can be shown on a display, for example. As at 202, a first augmented installation object is generated, such as in response to a user request as exemplified by FIGS. 4 through 6, for example, and is displayed as an overlay on the first image. As at 204, first input is received in response to the first image with the virtually displayed overlay, and as at 206, a first display change is generated and recorded based on the first input. In this example, the first input can take the form of a notation such as shown in various forms in FIGS. 13 through 17. As at 208, a second image of the installation environment is received. As at 210, second input is received in response to the second image, and as at 212, a second display change is generated and recorded based on the second input. In this example, the second input can take the form of a notation such as shown in various forms in FIGS. 13 through 17. In some cases, the second image can be supplemented with the first augmented installation object, just as the first image was supplemented. In other cases, the second image can be supplemented with a second augmented installation object that is different from the first installation object. In still other cases, the second image is not supplemented with an augmented installation object, but rather may just show the installation environment, which may be supplemented with one or more notations for reference and/or comparison with the first display change. Ultimately, the first and second images can be captured, supplemented as appropriate and recorded/saved as a project involving a collection or grouping of images for later use such as in obtaining a landowner approval of a project, for example. As at 214, a notification is issued including the recorded display changes. The notification can be, for example, a communication to another user such as a landowner, a regulating authority or other user for approval, comments, additional instructions to the end user, suggested changes and other such further input.

It will be appreciated that the system, device and method as described herein and shown in the drawings can be employed for businesses and consumers across multiple industries including, for example and without limitation, automotive retailers who desire to sell and install new electric charging stations for commercial and residential customers, third party solar panel providers looking to convert residential and commercial customers, windmill providers looking to install and sell equipment, landscaping design firms, residential design firms, commercial design firms, and cable companies looking to underground cable lines.

Unless otherwise stated, devices or components of the present disclosure that are in communication with each other do not need to be in continuous communication with each other. Further, devices or components in communication with other devices or components can communicate directly or indirectly through one or more intermediate devices, components or other intermediaries. Further, descriptions of embodiments of the present disclosure herein wherein several devices and/or components are described as being in communication with one another does not imply that all such components are required, or that each of the disclosed components must communicate with every other component. In addition, while algorithms, process steps and/or method steps may be described in a sequential order, such approaches can be configured to work in different orders. In other words, any ordering of steps described herein does not, standing alone, dictate that the steps be performed in that order. The steps associated with methods and/or processes as described herein can be performed in any order practical. Additionally, some steps can be performed simultaneously or substantially simultaneously despite being described or implied as occurring non-simultaneously.

The present disclosure contemplates a variety of different systems each having one or more of a plurality of different features, attributes, or characteristics. A “system” as used herein refers to various configurations of one or more computing devices, such as desktop computers, laptop computers, tablet computers, personal digital assistants, mobile phones, and other mobile computing devices. In various embodiments, the system of the present disclosure can be embodied as: (a) a single device such as device 20 in FIG. 1; (b) one or more computing devices in communication with a remote device such as remote device 35 in FIG. 2.

It will be appreciated that, when embodied as a system, the present embodiments can incorporate necessary processing power and memory for storing data and programming that can be employed by the processor(s) to carry out the functions and communications necessary to facilitate the processes and functionalities described herein. The present disclosure can be embodied as a device such as device 20 incorporating a hardware and software combination implemented so as to process images and other information as described herein. Such device need not be in continuous communication with computing devices on the network (e.g., 45).

It will be appreciated that algorithms, method steps and process steps described herein can be implemented by appropriately programmed general purpose computers and computing devices, for example. In this regard, a processor (e.g., a microprocessor or controller device) receives instructions from a memory or like storage device that contains and/or stores the instructions, and the processor executes those instructions, thereby performing a process defined by those instructions. Further, programs that implement such methods and algorithms can be stored and transmitted using a variety of known media.

Common forms of computer-readable media that may be used in the performance of the presently disclosed embodiments include, but are not limited to, floppy disks, flexible disks, hard disks, magnetic tape, any other magnetic medium, CD-ROMs, DVDs, any other optical medium, punch cards, paper tape, any other physical medium with patterns of holes, RAM, PROM, EPROM, FLASH-EEPROM, any other memory chip or cartridge, or any other medium from which a computer can read. The term “computer-readable medium” when used in the present disclosure can refer to any medium that participates in providing data (e.g., instructions) that may be read by a computer, a processor or a like device. Such a medium can exist in many forms, including, for example, non-volatile media, volatile media, and transmission media. Non-volatile media include, for example, optical or magnetic disks and other persistent memory. Volatile media can include dynamic random-access memory (DRAM), which typically constitutes the main memory. Transmission media may include coaxial cables, copper wire and fiber optics, including the wires or other pathways that comprise a system bus coupled to the processor. Transmission media may include or convey acoustic waves, light waves and electromagnetic emissions, such as those generated during radio frequency (RF) and infrared (IR) data communications.

Various forms of computer readable media may be involved in carrying sequences of instructions to a processor. For example, sequences of instruction can be delivered from RAM to a processor, carried over a wireless transmission medium, and/or formatted according to numerous formats, standards or protocols, such as Transmission Control Protocol/Internet Protocol (TCP/IP), Wi-Fi, Bluetooth, GSM, CDMA, EDGE and EVDO.

In embodiments in which the system or device is or includes a computing device configured to communicate through a data network, the data network is a local area network (LAN), a wide area network (WAN), a public network such as the Internet, or a private network. The computing devices as described herein can be configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network, satellite network or mobile Internet network), or any other suitable medium.

Where databases are described in the present disclosure, it will be appreciated that alternative database structures to those described, as well as other memory structures besides databases may be readily employed. The accompanying descriptions of any exemplary databases presented herein are illustrative and not restrictive arrangements for stored representations of data. Further, any exemplary entries of tables and parameter data represent example information only, and, despite any depiction of the databases as tables, other formats (including relational databases, object-based models and/or distributed databases) can be used to store, process and otherwise manipulate the data types described herein. Electronic storage can be local or remote storage, as will be understood to those skilled in the art.

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon. In certain embodiments, the system can employ any suitable computing device (such as a server) that includes at least one processor and at least one memory device or data storage device.

Computer program code for carrying out operations for aspects of the present disclosure may be written in any combination of one or more programming languages, including an object oriented programming language such as Java, Scala, Smalltalk, Eiffel, JADE, Emerald, C++, C #, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on a single device or on multiple devices.

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks. These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

It is to be understood that the above-described embodiments are merely illustrative of numerous and varied other embodiments which may constitute applications of the principles of the presently disclosed embodiments. Such other embodiments may be readily implemented by those skilled in the art without departing from the spirit of scope of this disclosure.

1. A device, comprising:
a display;
a processor; and
a memory storing instructions which, when executed by the processor, cause the processor to:
display a live camera feed of an installation environment on the display;
receive a selection of an augmented installation object;
display the first augmented installation object as a virtual overlay upon the live camera feed of the installation environment on the display;
receive an input in response to the display of the first installation object augmentation;
based on the input, generate and record a display change to the live camera feed; and
issue a notification regarding the display change.

2. The device of claim 1, wherein the display change comprises a supplement to the first augmented installation object.

3. The device of claim 1, wherein the input comprises a desired movement of the first augmented installation object.

4. The device of claim 1, wherein the input comprises a measurement of a distance pertaining to the first augmented installation object.

5. The device of claim 4, wherein the measurement of the distance is between the first augmented installation object and a physical object in the installation environment.

6. The device of claim 4, wherein the measurement of the distance is between the first augmented installation object and a virtual object generated on the display.

7. The device of claim 1, wherein the display change comprises at least one of: an augmentation object label, customer authorization, a notation, an address and geographic coordinates.

8. The device of claim 1, wherein the image of the installation environment comprises a first physical object, wherein the input comprises a desired removal of the first physical object, and wherein the display change comprises the desired removal such that the first physical object does not appear in the display after receipt of the input.

9. The device of claim 1, wherein the input comprises a desired second augmented installation object and wherein the display change comprises inserting the second augmented installation object.

10. The device of claim 1, wherein the image of the installation environment comprises an environment for the installation of equipment.

11. A computer-implemented method, comprising:
capturing an image of an installation environment via a camera;
generating, on a display of a communications device in communication with the camera, an augmented reality (“AR”) display comprising a first augmented installation object comprising a display overlain upon the image of the installation environment;
receiving an input, via the communications device, in response to the first installation object augmentation; and
based on the input, generating and recording a display change to the display.

12. The method of claim 11, wherein the display change comprises a supplement to the first augmented installation object.

13. The method of claim 11, wherein the input comprises a desired movement of the first augmented installation object.

14. The method of claim 11, wherein the input comprises a measurement of a distance pertaining to the first augmented installation object.

15. The method of claim 15, wherein the measurement of the distance is between the first augmented installation object and a physical object in the installation environment.

16. The method of claim 15, wherein the measurement of the distance is between the first augmented installation object and a virtual object generated on the display.

17. The method of claim 11, wherein the display change comprises at least one of: an augmentation object label, customer authorization, a notation, an address and geographic coordinates.

18. The method of claim 11, wherein the image of the installation environment comprises a first physical object, wherein the input comprises a desired removal of the first physical object, and wherein the display change comprises the desired removal such that the first physical object does not appear in the image after receipt of the input.

19. The method of claim 11, wherein the input comprises a desired second augmented installation object and wherein the display change comprises inserting the second augmented installation object.

20. A system, comprising:
a display;
a processor; and
a memory storing instructions which, when executed by the processor, cause the processor to:
receive a first image of an installation environment;
generate, on a display of a communications device, an augmented reality (“AR”) display comprising a first augmented installation object overlain upon the first image of the installation environment;
receive a first input, via the communications device, in response to the first augmented installation object;
based on the first input, generate and record a first display change to the first image, wherein the first display change comprises at least a verbal notation overlain upon the first image of the installation environment;
receive a second image of the installation environment;
generate and record a second display change to the second image, wherein the second display change comprises at least a verbal notation overlain upon the second image of the installation environment; and
issue a notification regarding the first and second display changes.
